(19) United States
(12) Patent Application Publication
(10) Pub. No.: US 2005/0027994 A1
(43) Pub. Date: Feb. 3, 2005

(54) Device key protection method, and encoding apparatus, decoding apparatus, video transmission apparatus and video receiving apparatus using the method

(76) Inventor: Baiko Sai, Ukyo-ku (JP)

Correspondence Address: CANTOR COLBURN, LLP, 55 GRIFFIN ROAD SOUTH, BLOOMFIELD, CT, 06002, US

(21) Appl. No.: 10/857,300

(22) Filed: May 28, 2004

(30) Foreign Application Priority Data
Apr. 30, 2003 (JP) JP2003-125959

(51) Int. Cl. G06F 12/14

(52) U.S. Cl. 713/189

(57) ABSTRACT

An HDCP encrypting section of an encrypting apparatus encrypts a content signal using a device key and transmits the encrypted signal. An HDCP decrypting section of a decrypting apparatus receives the encrypted content signal and decrypts the signal using the device key. Device key encryption processing software encrypts the device key using a predetermined private key and writes the encrypted device key in a memory of the encrypting apparatus. A device key protecting circuit reads the encrypted device key from the memory, decrypts the encrypted device key and supplies the decrypted device key to the HDCP encrypting section. In the event of an unauthorized access to the device key protecting circuit, a system reconstructing circuit reconstructs a scheme for decrypting the device key in the device key protecting circuit.

### BACKGROUND OF THE INVENTION

1. Field of the Invention

The present invention relates to a method of protecting a device key for authenticating a digital encryption processing apparatus, and further to an encrypting apparatus, a decrypting apparatus, an image transmitting apparatus and an image receiving apparatus in which the method may be used.

2. Description of the Related Art

Digital Visual Interface (DVI) is known as a standard for digital transmission of a video signal to a liquid crystal display (LCD) monitor or a cathode-ray tube (CRT) monitor. A problem with analog transmission of video signal to a LCD monitor or a CRT monitor is that quality of images as viewed on a screen may easily be degraded due, for example, to distortion in waveforms. In the DVI standard, a video signal is transmitted using a digital encoding scheme so that no distortion occurs in transmission. As a result, high-quality images are displayed on a screen. Other emerging applications of the DVI standard include connection of a set top box for digital broadcast or cable broadcast to a digital television set, and connection of a digital player such as a digital video disk (DVD) player to an LCD monitor for display of digital images.

With the DVI standard, high-quality image contents are available. Therefore, it is necessary to enhance copyright protection to prevent unauthorized reproduction and illegal copying of image contents supplied. High-Bandwidth Digital Content Protection System (HDCP) is known as a scheme of protecting digital contents adapted for the DVI standard. The HDCP standard is a standard adapted for a system of transmitting image signals using the DVI standard and is designed to ensure secure transmission of image contents requiring copyright protection. The HDCP prescribes authentication between a transmitting apparatus and a receiving apparatus, sharing of a key for authentication, and specification for encryption of an image signal transmitted.

In the type of authentication such as that of HDCP, a device key is used to individually authenticate apparatuses at the other end of communication, using a public key encryption. If authentication is successful between a transmitting apparatus and a receiving apparatus, the transmitting apparatus encrypts an image signal using a device key and transmits the encrypted signal. The receiving apparatus decrypts the received image signal using the device key. For example, a reference listed below discloses a digital image transmitting apparatus using an authentication scheme of the type used in the HDCP.

Reference: Japanese Laid-Open Patent Application No. 2002-314970 (entire text, FIGS. 1-3)

A device key for individual authentication of apparatuses that process an image signal is written, at factory shipping, in an external memory such as an electrically erasable programmable read-only memory (EEPROM), or an internal memory that can be written and read by an external means. The device key is written in the external memory or the internal memory without any protection applied. It is therefore easy to access the external memory or the internal memory to obtain a dead copy of the device key or to steal device key data by eavesdropping a signal on a serial bus connecting the external memory and the apparatus. Since acquisition of the device key with a malicious intent cannot be prevented, there is likelihood that image contents are used by unauthorized users and the copyright thereof is infringed.

The number of consumer-oriented products such as DVD players, set top boxes and digital television sets is quite large and there are an equally large number of device keys published commensurate with the number of products. Consequently, it is not possible to identify an unauthorized use immediately when a minority of the keys is reproduced by dead copies. Post facto discovery of a dead copy of the device key and tracking of a route of acquisition are difficult. Even when an unauthorized use of the device key is learned, it is difficult to reconstruct a system to change a scheme for encryption and decryption of the device key.

### SUMMARY OF THE INVENTION

The present invention has been made in view of these circumstances and its object is to provide a method of protecting a device key for authenticating an apparatus processing a digital signal such as an image signal and an audio signal, and an encrypting apparatus, a decrypting apparatus, an image signal transmitting apparatus and an image signal receiving apparatus in which the method may be used.

One mode of practicing the invention relates to a method of protecting a device key. The method comprises providing, in an apparatus for processing an input digital signal, a device key protecting circuit for decrypting a device key for individually authenticating the apparatus; and encrypting the device key at factory shipping of the apparatus and writing the encrypted device key in a memory readable from the apparatus. The memory may be provided outside the apparatus in the form of a writable EEPROM or a flash memory. Alternatively, the memory may be installed inside the apparatus. In side the apparatus, a system reconstructing circuit may be provided for reconstructing a scheme for decrypting the device key in the device key protecting circuit, against unauthorized access to the device key protecting circuit. The digital signal may be an image signal, an audio signal or a combination of both. The processing apparatus may be a digital transmission apparatus or a digital reception apparatus.

Another mode of the invention also relates to an encrypting apparatus for a digital signal. The apparatus comprises: a memory for storing an encrypted device key for individually authenticating the apparatus; a device key protecting circuit for reading the encrypted device key from the memory and decrypting the device key; and an encrypting section for encrypting an input digital signal using the decrypted device key. The device key protecting circuit and the encrypting section may be implemented as an LSI circuit inside the apparatus. With this, decryption of the device key is processed internally in the LSI circuit, prohibiting eavesdropping. The memory may be provided on an LSI circuit substrate. A data transmission path from the memory to the device key protecting circuit may comprise an external bus such as a serial bus so that eavesdropping of a signal on the bus is possible.

Still another mode of practicing the invention relates to a decrypting apparatus for a digital signal. The digital signal decrypting apparatus comprises: a memory for storing an encrypted device key for individually authenticating the apparatus; a device key protecting circuit for reading the encrypted device key from the memory and decrypting the device key; and a decrypting section for decrypting an input encrypted digital signal using the decrypted device key.

The encrypting apparatus and the decrypting apparatus may further comprise a system reconstructing circuit for generating a work key using a predetermined private key and a public key corresponding to the device key, wherein the device key protecting circuit may decrypt the device key using the work key generated by the system reconstructing circuit. In the even of an attack to the device key protecting circuit, the scheme for decrypting the device key in the device key protecting circuit may be reconstructed, by changing the private key.

Yet another mode of practicing the invention relates to an image transmitting apparatus. The image transmitting apparatus comprises: an encryption processing block for encrypting an input image signal; and an image transmission processing block for encoding the encrypted image signal and transmitting the encoded signal, wherein the encryption processing block comprises: a memory for storing an encrypted device key for authentication using a public key; a system reconstructing circuit for generating a work key using a predetermined private key and a public key corresponding to the device key; a device key protecting circuit for reading the encrypted device key from the memory and decrypts the device key using the work key; and an encrypting section for encrypting the image signal using the decrypted device key.

Yet another mode of practicing the invention relates to an image receiving apparatus. The image receiving apparatus comprises: an image reception processing block for receiving an encoded image signal and decoding the encoded image signal; and a decryption processing block for decrypting the encrypted image signal thus decoded, wherein the decryption processing block comprises: a memory for storing an encrypted device key for authentication using a public key; a system reconstructing circuit for generating a work key using a predetermined private key and a public key corresponding to the device key; a device key protecting circuit for reading the encrypted device key from the memory and decrypts the device key using the work key; and a decrypting section for decrypting the encrypted image signal using the decrypted device key.

Optional combinations of the aforementioned constituting elements and implementations of the invention in the form of methods, apparatuses and systems, recording mediums, computer programs and semiconductor devices may also be practiced as additional modes of the present invention.

Moreover, this summary of the invention does not necessarily describe all necessary features so that the invention may also be sub-combination of these described features.

### BRIEF DESCRIPTION OF THE DRAWINGS

FIG. 1 shows a construction of a transmission system for transmitting a content signal according to the first embodiment of the present invention.

FIG. 2 illustrates a construction of device key encryption processing software.

FIG. 3 illustrates a construction of an encrypting apparatus of FIG. 1.

FIG. 4 illustrates a construction of a decrypting apparatus of FIG. 1.

FIG. 5 shows a construction of an image signal transmitting apparatus according to the second embodiment of the present invention.

FIG. 6 shows a construction of an image signal receiving apparatus according to the second embodiment of the present invention.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

First Embodiment

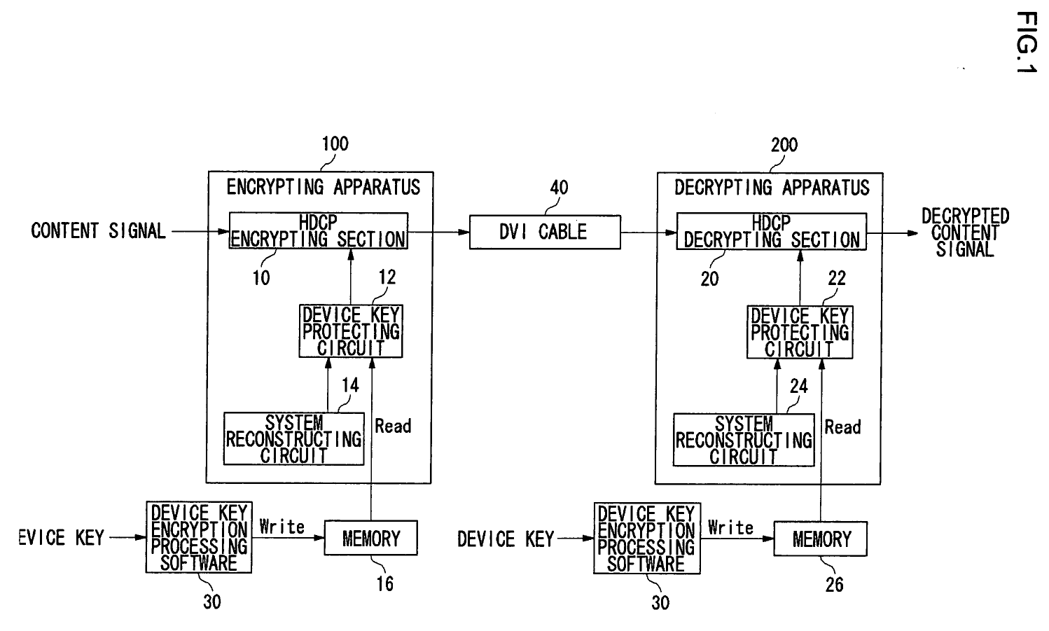

FIG. 1 shows a construction of a transmission system for transmitting a content signal according to the first embodiment of the present invention. An encrypting apparatus 100 receives an input of a content signal including an image signal and an audio signal. A HDCP encrypting section 10 encrypts the input content signal in accordance with the HDCP standard and transmits the encrypted signal to a DVI cable 40 via a DVI terminal. A decrypting apparatus 200 receives, via a DVI terminal, the encrypted content signal transmitted on the DVI cable 40. A HDCP decrypting section 20 decrypts the received content signal in accordance with the HDCP standard and outputs the decrypted content signal. The output content signal is fed to a display, speaker etc. for reproduction of the content.

According to the HDCP standard, a source device (also referred to as a transmitter) transmitting a content signal and a sink device (also referred to as a receiver) receiving the content signal authenticate each other in accordance with a public key encryption scheme so that an encrypted content signal is transmitted. The encrypting apparatus 100 corresponds to a source device, and the decrypting apparatus 200 corresponds to a sink device. For authentication and encryption purposes, the encrypting apparatus 100 and the decrypting apparatus 200 share respective public keys. A private key kept secret to each apparatus is referred to as a device key. A public key corresponding to the device key (hereinafter, simply referred to as a device public key) is called a key selection vector (KSV). The encrypting apparatus 100 and the decrypting apparatus 200 authenticate each other using pairs of the device keys and device public keys. When the authentication is successful, the encrypting apparatus 100 encrypts a content signal to be transmitted to the decrypting apparatus 200 using the device key. The decrypting apparatus 200 decrypts the encrypted content signal received from the encrypting apparatus 100 using the device key.

In order to protect the device key used for authentication of the apparatuses and encryption of the content signal from unauthorized access or dead copying, device key encryption processing software 30 encrypts the device key with a predetermined private key and writes the encrypted key in a memory 16 of the encrypting apparatus 100.

A device key protecting circuit 12 of the encrypting apparatus 100 reads the encrypted device key from the memory 16 so as to decrypt the encrypted device key. The device key protecting circuit 12 supplies the decrypted device key to the HDCP encrypting section 10. The HDCP encrypting section 10 encrypts the input content signal using the decrypted device key and outputs the encrypted content signal. Data of the device key carried on a data transmission path connecting the memory 16 and the device key protecting circuit 12 is encrypted and cannot be used even if acquired by unauthorized access. The encrypted device key is decrypted by the device key protecting circuit 12 in the encrypting apparatus 100 and supplied to the HDCP encrypting section 10 via an internal bus. With this, data of the decrypted device key cannot be acquired unless the circuit is reverse-engineered.

A system reconstructing circuit 14 reconstructs a scheme for decrypting the device key in the device key protecting circuit 12 when the device key protecting circuit 12 is attached by unauthorized access such as exhaustive search or reverse engineering. An example of unauthorized access is an act of stealing data of the decrypted device key output from the device key protecting circuit 12, collecting patterns for mapping the encrypted device keys into the decrypted device keys, and analyzing a scheme for decryption. When such an attack to the device key takes place, the device key encryption processing software 30 changes the scheme for encrypting the device key. Correspondingly, the system reconstructing circuit 14 reconstructs the scheme for decryption in the device key protecting circuit 12. With this, the scheme for decrypting the device key is updated and unauthorized use of the device key is prevented.

The HDCP encrypting section 10, the device key protecting circuit 12, the system reconstructing circuit 14 are built on a common substrate to constitute an LSI circuit. The memory 16 is formed as an EEPROM on the substrate. When the circuit substrate is shipped, the device key encrypted by the device key encryption processing software 30 is written in the EEPROM. In the event of an unauthorized access, a user allows the device key encryption processing software 30 to encrypt the device key using a new encryption scheme so as to update the encrypted device key in the memory 16. Correspondingly, the system reconstructing circuit 14 is directed by a controller such as a CPU on the substrate to change the decrypting scheme employed in the device key protecting circuit 12.

The construction and operation of a memory 26, a device key protecting circuit 22 and a system reconstructing circuit 24 of the decrypting apparatus 200 are the same as the construction and operation of the memory 16, the device key protecting circuit 12 and the system reconstructing circuit 14 of the encrypting apparatus 100. The device key protecting circuit 22 supplies the decrypted device key to the HDCP decrypting section 20. The HDCP decrypting section 20 decrypts the encrypted content signal using the decrypted device key and outputs the decrypted content signal.

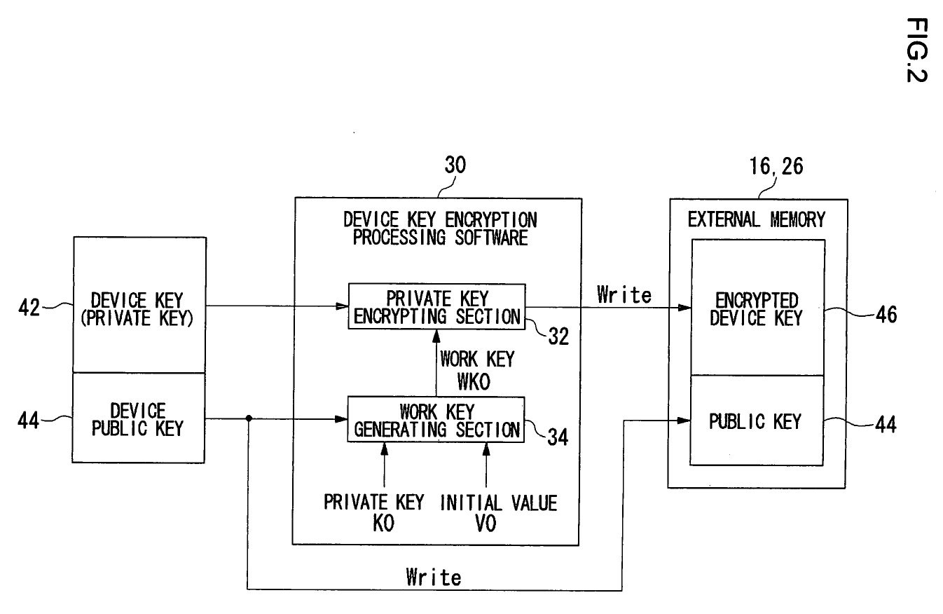

FIG. 2 shows a construction of the device key encryption processing software 30. The device key encryption processing software 30 receives an input of a pair of a device private key 42 and a device public key 44. A work key generating section 34 generates a work key WK0 using a predetermined private key K0, an initial value V0 and the device public key 44 and supplies the work key WK0 to a private key encrypting section 32. The private key encrypting section 32 encrypts the device key 42 using the work key WK0 and writes the encrypted device key 46 in the memories 16 and 26. A public key corresponding to the device key 42 is also written in the memories 16 and 26. By changing the private key K0, a different work key WK0 is generated so that a pattern for encrypting the device key 42 is changed.

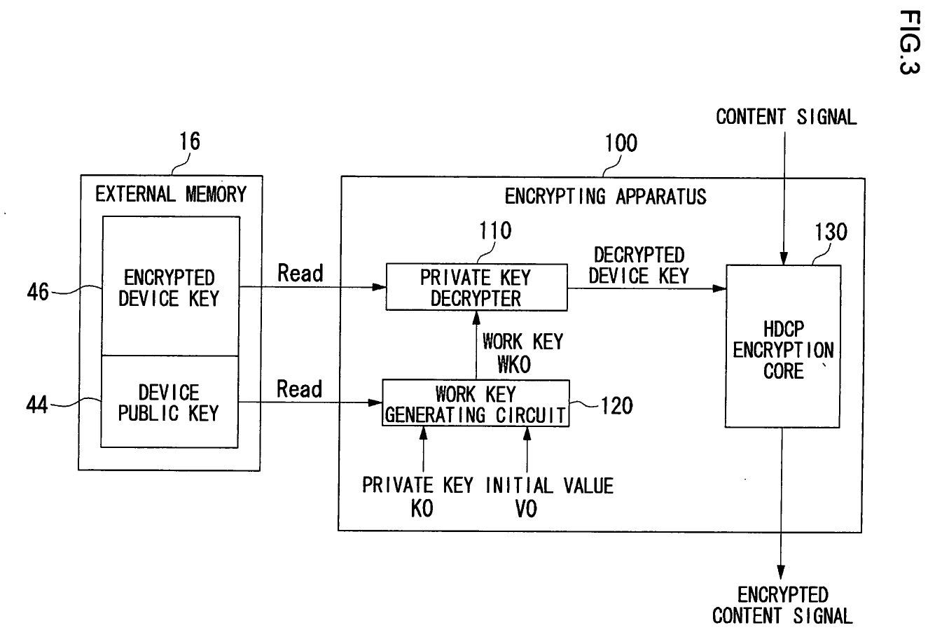

FIG. 3 shows a construction of the encrypting apparatus 100. While FIG. 1 gives a conceptual illustration, a detailed description of the functional construction will now be given by referring to FIG. 3. Corresponding to the device key protecting circuit 12 and the system reconstructing circuit 14 of FIG. 1 are a private key decrypter 110 and a work key generating circuit 120 shown in FIG. 3.

The work key generating circuit 120 reads the device public key 44 from the memory 16 and reads the predetermined private key K0 and the initial value V0. The private key K0 and the initial value V0 are the same as those used by the device key encryption processing software 30 of FIG. 2. The work key generating circuit 120 generates the work key WK0 using the private key WO, the initial value V0 and the device public key 44 and supplies the work key WK0 to the private key decrypter 110. The private key decrypter section 110 reads the encrypted device key 46 from the memory 16 and decrypts the device key 46 using the work key WK0. The device key decrypted by the private key decrypter 110 is supplied to an HDCP encryption core 130.

The HDCP encryption core 130 is an encryption processing circuit complying with the HDCP standard and has the function of authenticating an apparatus at the other end of communication, sharing a key with the apparatus, and encrypting a content signal using the shared key. The HDCP encryption core 130 uses the device key decrypted by the private key decrypter 210 to encrypt the input content signal and outputs the encrypted content signal.

By changing the private key K0 input to the work key generating circuit 120, a different work key WK0 is generated so that a pattern for decrypting the encrypted device key 46 is changed. In the event of an unauthorized act such as analyzing of a decryption scheme in the private key decrypter 110, the private key K0 used in the device key encryption processing software 30 of FIG. 2 is changed so that an encryption pattern is changed. Correspondingly, the private key K0 input to the work key generating circuit 120 is also changed. With this, the decryption scheme in the private key decrypter 110 is reconstructed and unauthorized decryption of the encrypted device key 46 is prevented.

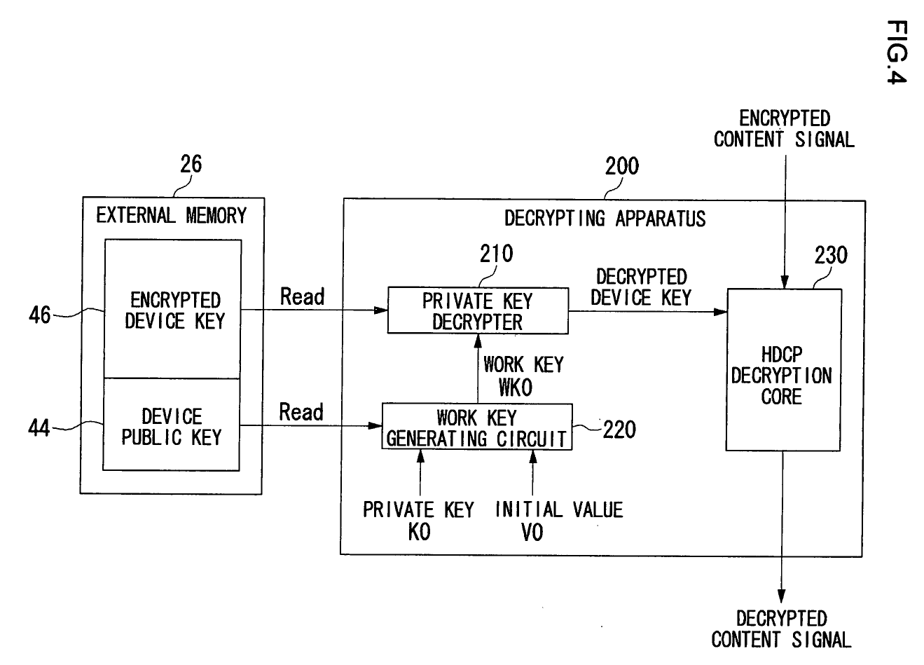

FIG. 4 illustrates a construction of the decryption apparatus 200. The private key decrypter 210 and the work key generating circuit 220 reading a pair of the encrypted device key 46 and the device public key 44 from the memory 26 so as to decrypt the encrypted device 46 are the same as the private key decrypter 110 and the work key generating circuit 120 of FIG. 3. An HDCP decryption core 230 is a decryption processing circuit complying with the HDCP standard and has the function of authenticating an apparatus at the other end of communication, sharing a key with the apparatus, and decrypting a content signal using the shared key. The HDCP decryption core 230 uses the device key decrypted by the private key decrypter 210 to decrypt the encrypted content signal and outputs the decrypted content signal. In a similar configuration as the encrypting apparatus 100, the decrypting apparatus 200 is capable of reconstructing a decrypting scheme in the private key decrypter 210 by changing the private key K0 input to the work key generating circuit 220.

Second Embodiment

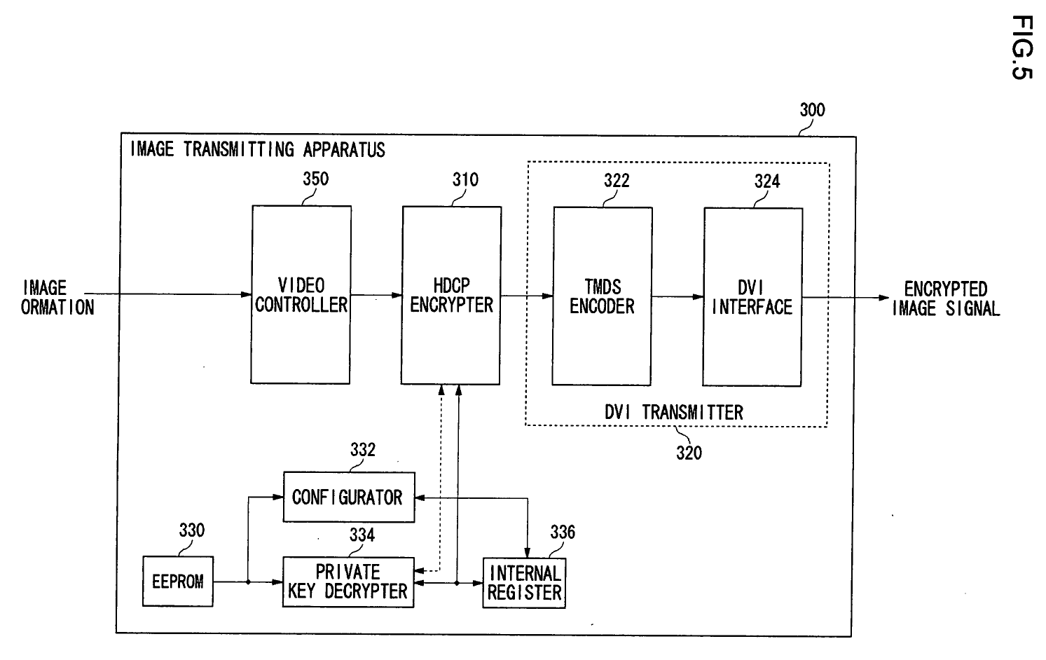

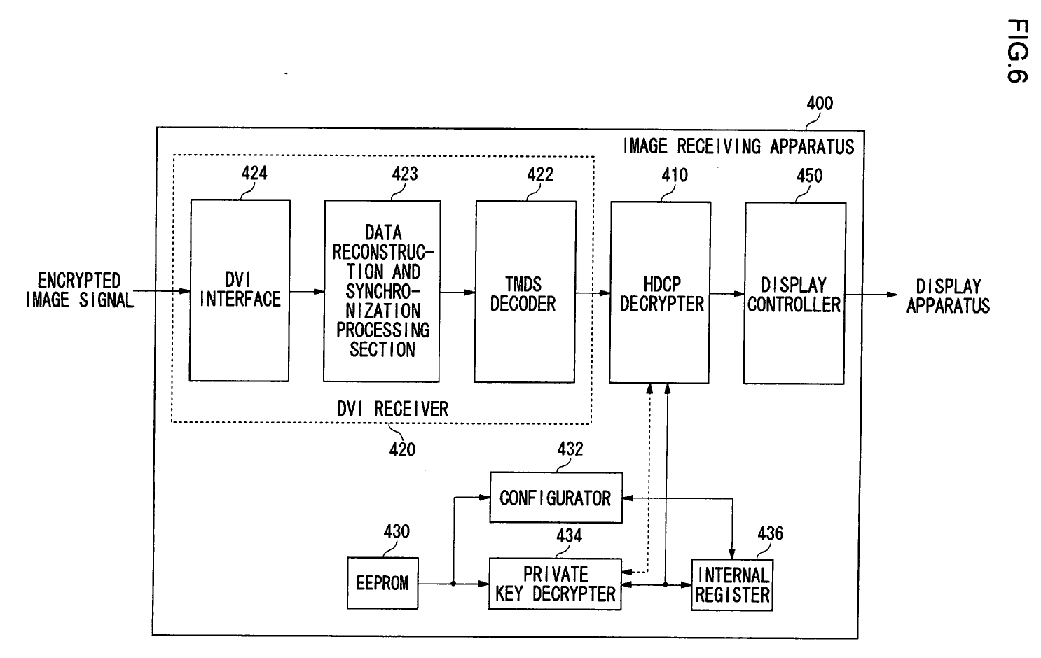

The second embodiment is an embodiment in which the encrypting apparatus 100 and the decrypting apparatus 200 according to the first embodiment are applied to a transmission system for an image signal complying with the DVI standard. A transmission system complying with the DVI standard is composed of an image transmitting apparatus 300 of FIG. 5 and an image receiving apparatus 400 of FIG. 6 connected to each other via a transmission path.

The image transmitting apparatus 300 and the image receiving apparatus 400 may be implemented as a DVI transmitter LSI and a DVI receiver LSI, respectively. For example, the image transmitting apparatus 300 may be used as a video output section of a personal computer. The image receiving apparatus 400 may be used as a video input section of a display apparatus such as an LCD display. The video output section and the video input section are connected to each other using a DVI cable so that an image signal is digitally transmitted. Alternatively, the image transmitting apparatus 300 may be used as a video output section of a set top box. The image receiving apparatus 400 may be used as a video input section of a digital television set connected to a set top box. In another alternative arrangement, the image transmitting apparatus 300 may be used as a video output section of a DVD player. The image receiving apparatus 400 may be used as a video input section of an LCD display connected to a DVD player.

FIG. 5 shows a construction of the image transmitting apparatus 300 according to the second embodiment. The image transmitting apparatus 300 includes a video controller 350 receiving an input of image information and outputting a digital image signal, an HDCP encrypter 310 encrypting the image signal in accordance with the HDCP standard, and a DVI transmitter 320 transmitting the encrypted image signal in accordance with the DVI standard. The construction and operation of the HDCP encrypter 310 are similar to those of the HDCP encryption core 130 described by referring to FIG. 3. The HDCP encrypter 310 encrypts the image signal using a device key and supplies the encrypted image signal to the DVI transmitter 320.

A TMDS encoder 322 of the DVI transmitter 320 encodes four channels including encrypted R, G and B color signals and a synchronization signal in accordance with a transition minimized differential signaling (TMDS) scheme and transmits the encoded signal in a differential signaling scheme using two signal lines. A DVI interface 324 serializes the encoded signal and transmits the serialized signal to a transmission path via the DVI terminal. The image transmitting apparatus 300 thus transmits the encrypted image signal to the image receiving apparatus 400 via the DVI cable.

An EEPROM 330 corresponds to the memory 16 of FIG. 3. A pair of the device key 46 and the device public key 44 described by referring to FIG. 3 is written at factory shipping in the EEPROM 330 of the image transmitting apparatus 300. The private key K0 and the initial value V0 for generating the work key WK0 of FIG. 3 are also written in the EEPROM 330.

A configurator 332 has the function corresponding to that of the work key generating circuit 120. The configurator 332 reads the private key K0, the initial value V0 and the device public key 44 from the EEPROM 330 and stores them in an internal register 336. The configurator 332 then generates the work key WK0 using the data and stores the work key WK0 thus generated in the internal register 336.

A private key decrypter 334 corresponds to the private key decrypter 110 described by referring to FIG. 3. The private key decrypter 334 reads the encrypted device key 46 from the EEPROM 330 and reads the work key WK0 generated by the configurator 332 from the internal register 336. The private key decrypter 334 decrypts the encrypted device key 46 using the work key WK0 and supplies the decrypted device key 46 to the HDCP encrypter 310. The path indicated by the dotted line from the private key decrypter 334 to the HDCP encrypter 310 is an internal bus of the LSI and therefore the path is immune to attacks even if it carries the device key that is not encrypted.

FIG. 6 shows a construction of the image receiving apparatus 400 according to the second embodiment. The image receiving apparatus 400 includes a DVI receiver 420 receiving an encrypted image signal in accordance with the DVI standard, a HDCP decrypter 410 decrypting the received image signal in accordance with the HDCP standard, and a display controller 450 subjecting the decrypted image signal to signal processing so as to supply the same to a display apparatus.

A DVI interface 424 of the DVI receiver 420 receives the encrypted image signal from the image transmitting apparatus 300. A data reconstruction and synchronization processing section 423 reconstructs and synchronizes data in the image signal and supplies the resultant signal to a TMDS decoder 422. The TMDS decoder 422 decodes the encoded image signal in accordance with the TMDS scheme so as to isolate the R, G and B color signals and the synchronization signal from each other and supply the resultant signals to the HDCP decrypter 410. The construction and operation of the HDCP decrypter 410 are similar to those of the HDCP decryption core 230 described by referring to FIG. 4. The HDCP decrypter 410 decrypts the encrypted image signal using the device key and supplies the decrypted signal to the display controller 450.

The EEPROM 430, the configurator 432, the private key decrypter 434 and the internal register 436 execute the same processes as executed by the EEPROM 330, the configurator 332, the private key decrypter 334 and the internal register 336 in the image transmitting apparatus 300 of FIG. 5, respectively. The decrypted device key is safely supplied from the private key decrypter 434 to the HDCP decrypter 410.

As described above, according to the embodiment, the device key stored in the memory is encrypted by software before the storage. When used, the device key is read into the main LSI device via an external bus. Since the encrypted device key cannot be used by unauthorized user in combination with other devices, key information is prevented from being leaked even if a dead copy of the device key is taken from the memory or the device key data is acquired by eavesdropping the external bus signal. Since the device key read from the memory is deciphered inside the main LSI device, data of the decrypted device key cannot be acquired unless the device is internally reverse-engineered. With the reinforced protection of the device key as described above, safety of system is improved.

Moreover, even if the protection scheme of the device key protecting circuit inside the LSI device is attacked, the system can easily be reconstructed by changing the device key protection software, the configuration of the device key protecting circuit and the private key used in the device key protecting circuit. In the even of an attack, the device key protecting circuit may be disabled by an initial setting of the LSI device. Since unauthorized accesses are dealt with flexibly as described above, the convenience of system is improved.

Described above is an explanation of the present invention based on the embodiment. The embodiment of the present invention is only illustrative in nature and it will be understood to those skilled in the art that various variations in constituting elements and processes are possible within the scope of the present invention.

In the second embodiment, a variation in which the method of protecting a device key is used in an image transmitting device and a receiving device complying with the DVI standard. The method is equally applicable, however, to the High Definition Multimedia Interface (HDMI) standard. The HDMI standard is a next-generation audio/visual interface standard with downward compatibility with DVI but with a variety of additional functions adapted for home electronics appliances. With HDMI, it is possible to transmit a high-quality audio signal as well as a video signal and to transmit a control signal for remote control. The HDCP standard adapted for the HDMI standard is provided so that the method of protecting a device according to the second embodiment is also applicable to a transmitting device and a receiving device complying with the HDMI standard.

Although the present invention has been described by way of exemplary embodiments, it should be understood that many changes and substitutions may further be made by those skilled in the art without departing from the scope of the present invention which is defined by the appended claims.

1. A device key protecting method comprising:
providing, inside an apparatus for processing an input digital signal, a device key protecting circuit for decrypting a device key for individually authenticating said apparatus; and
encrypting the device key at factory shipping of said apparatus and writing the encrypted device key in a memory readable from said apparatus.

2. The device key protecting method according to claim 1, further comprising providing, inside said apparatus, a system reconstructing circuit for reconstructing a scheme for decrypting the device key in the device key protecting circuit, against unauthorized access to the device key protecting circuit.

3. A digital signal encrypting apparatus comprising:
a memory for storing an encrypted device key for individually authenticating said apparatus;
a device key protecting circuit for reading the encrypted device key from said memory and decrypting the device key; and
an encrypting section for encrypting an input digital signal using the decrypted device key.

4. The encrypting apparatus according to claim 3, further comprising a system reconstructing circuit for generating a work key using a predetermined private key and a public key corresponding to the device key, wherein said device key protecting circuit decrypts the device key using the work key generated by said system reconstructing circuit.

5. The encrypting apparatus according to claim 4, wherein the scheme for decrypting the device key in the device key protecting circuit is reconstructed, by changing the private key.

6. A digital signal decrypting apparatus comprising:
a memory for storing an encrypted device key for individually authenticating said apparatus;
a device key protecting circuit for reading the encrypted device key from said memory and decrypting the device key; and
a decrypting section for decrypting an input encrypted digital signal using the decrypted device key.

7. The decrypting apparatus according to claim 6, further comprising a system reconstructing circuit for generating a work key using a predetermined private key and a public key corresponding to the device key, wherein said device key protecting circuit decrypts the device key using the work key generated by said system reconstructing circuit.

8. The decrypting apparatus according to claim 7, wherein the scheme for decrypting the device key in the device key protecting circuit is reconstructed, by changing the private key.

9. An image transmitting apparatus comprising:
an encryption processing block for encrypting an input image signal; and
an image transmission processing block for encoding the encrypted image signal and transmitting the encoded signal, wherein
said encryption processing block comprises:
a memory for storing an encrypted device key for authentication using a public key encryption;
a system reconstructing circuit for generating a work key using a predetermined private key and a public key corresponding to the device key;
a device key protecting circuit for reading the encrypted device key from the memory and decrypts the device key using the work key; and
an encrypting section for encrypting the image signal using the decrypted device key.

10. An image receiving apparatus comprising:
an image reception processing block for receiving an encoded image signal and decoding the encoded image signal; and
a decryption processing block for decrypting the encrypted image signal thus decoded, wherein
said decryption processing block comprises:
a memory for storing an encrypted device key for authentication using a public key encryption;
a system reconstructing circuit for generating a work key using a predetermined private key and a public key corresponding to the device key;
a device key protecting circuit for reading the encrypted device key from the memory and decrypts the device key using the work key; and
a decrypting section for decrypting the encrypted image signal using the decrypted device key.
